(19) United States
(12) Patent Application Publication
(10) Pub. No.: US 2026/0325997 A1
(43) Pub. Date: Oct. 22, 2026

(54) FILTER CARTRIDGE ASSEMBLY AND WATER PURIFICATION DEVICE

(71) Applicants: FOSHAN MIDEA CHUNGHO WATER PURIFICATION EQUIPMENT CO., LTD., Foshan (CN); MIDEA GROUP CO., LTD., Foshan (CN)

(72) Inventors: Tingjian HUANG, Foshan (CN); Peng GUI, Foshan (CN); Weiming CHEN, Foshan (CN)

(21) Appl. No.: 18/879,565

(22) PCT Filed: Nov. 14, 2024
(86) PCT No.: PCT/CN2024/132122

§ 371 Date: Dec. 27, 2024

(30) Foreign Application Priority Data
Dec. 28, 2023 (CN) 202323621463.3

(51) Int. Cl. B01D 29/96; B01D 29/23

(52) U.S. Cl. CPC B01D 29/96; B01D 29/23; B01D 2201/295; B01D 2201/4084; B01D 2201/4092

(57) ABSTRACT

A filter cartridge assembly includes filter cartridge base body having mount cavity and mount port communicating with the mount cavity and including first snap member(s) at inner wall thereof and extending obliquely along circumference direction thereof, filter cartridge body inside the mount cavity and including first end with interface(s) communicating with water path plate and second end with rotatable connector, and end cover at the mount port and connected to the filter cartridge body through the rotatable connector. Outer peripheral wall of the end cover has second snap member(s) corresponding to and engaging with the first snap member(s), respectively, in threaded fit. Ratio of sum of abutment area(s) between the first and second snap members to sum of water passage area(s) of the interface(s) is greater than or equal to 1.3 and less than or equal to 3.

### CROSS-REFERENCE TO RELATED APPLICATION

The present application claims priority to Chinese patent application No. 2023236214633 filed on Dec. 28, 2023, entitled “Filter Cartridge Assembly and Water Purification Device,” which is incorporated herein by reference in its entirety.

### FIELD

The present application relates to the field of water purification, particularly to a filter cartridge assembly and a water purification device.

### BACKGROUND

Water purification product is a type of water purifier which is a water treatment device that deeply filters and purifies water based on water usage requirements. The water purifier may effectively filter out rust, sand, colloid in the water, absorb residual chlorine, odor, strange color, pesticide and other chemical agents in the water, as well as remove impurities such as bacteria, pathogen, toxin, heavy metal, etc. from the water. It is widely used in both civilian and commercial applications.

In related fields, a connection manner between an end cover and a housing or support base in a filter cartridge assembly is generally rotational mounting by rotating and snapping to replace a filter cartridge. Since an end of a filter cartridge provided with a water inlet port and a water outlet port and an end connected to the end cover are axially opposite ends, in case that a water port of the filter cartridge is along an axial direction, a force required for fixing the filter cartridge is a product of a difference in axial force areas and a water pressure. The difference in force areas are areas of the water inlet port and the water outlet port. However, to ensure structural strength, the conventional filter cartridge assembly has been set to have excessive strength of a fixed structure, resulting in a large volume of the filter cartridge assembly, increased production costs, and an overall increase in a volume of the water purification device, which affects user experiences.

### BRIEF SUMMARY

The present application aims to solve at least one of the problems in the related art. The present application provides a filter cartridge assembly, which realizes match between suitable water flow rate and a strength of fixed structure of the filter cartridge assembly, improving the structural performance and filtration efficiency of the filter cartridge assembly.

The present application further provides a water purification device.

The filter cartridge assembly of the present application includes:
a filter cartridge base body, where the filter cartridge base body is provided with a mount cavity and a mount port communicating with the mount cavity, an inner wall of the mount port is provided with a first snap member, and the first snap member is provided to extend obliquely along a circumference direction of the mount port;
a filter cartridge body, where the filter cartridge body is provided inside the mount cavity, an end of the filter cartridge body is provided with a first interface communicating with a water path plate, and another end of the filter cartridge body is provided with a rotatable connector; and
an end cover, where the end cover is correspondingly provided at the mount port, the end cover is rotatably connected to the filter cartridge body through the rotatable connector, an outer peripheral wall of the end cover is provided with a second snap member corresponding to the first snap member, and the first snap member and the second snap member match each other through rotating and snapping, to lock the filter cartridge body inside the mount cavity;
where a ratio of a sum of abutment area between the first snap member and the second snap member to a sum of water passage area of the first interface is greater than or equal to 1.3 and less than or equal to 3.

In some embodiments, one of the first snap member and the second snap member is a snap protrusion, and another is a guide slot.

In some embodiments, the snap protrusion is provided with an abutment surface away from a side of the filter cartridge body.

In some embodiments, the abutment surface is provided to abut against a side wall of the guide slot facing the filter cartridge body in an axial direction.

In some embodiments, a height H of the snap protrusion protruding in a radial direction is greater than or equal to 2.5 mm and less than or equal to 6.5 mm.

In some embodiments, a thickness d of the snap protrusion along an axis direction is greater than or equal to 5 mm and less than or equal to 12 mm.

In some embodiments, a length of the snap protrusion extending in a circumferential direction is L.

In some embodiments, a diameter of the first interface is D.

In some embodiments, a ratio of a sum of the lengths of all the snap protrusions extending in the circumferential direction to a sum of the diameters of all the first interfaces is greater than or equal to 3 and less than or equal to 7.

In some embodiments, an outer periphery edge of the end cover toward the filter cartridge body is provided with a flange.

In some embodiments, the flange is provided to cover the end of the filter cartridge body provided with the rotatable connector.

In some embodiments, the snap protrusion is provided at an outer wall surface of the flange.

In some embodiments, a side of the end cover away from the filter cartridge body is raised to form a grip member.

In some embodiments, an outer peripheral edge of an end of the grip member away from the filter cartridge body protrudes to form an undercut.

In some embodiments, a raise distance of the grip member along an axial direction of the end cover is h.

In some embodiments, h is greater than or equal to 12 mm.

The present application further provides a water purification device, which includes an outer housing and any of the above filter cartridge assemblies. The filter cartridge assembly includes a filter cartridge base body, a filter cartridge body, and an end cover. The filter cartridge base body is provided with a mount cavity and a mount port communicating with the mount cavity. An inner wall of the mount port is provided with a first snap member, where the first snap member is provided to extend obliquely along a circumference direction of the mount port. The filter cartridge body is provided inside the mount cavity, an end of the filter cartridge body is provided with a first interface communicating with a water path plate, and another end of the filter cartridge body is provided with a rotatable connector. The end cover is correspondingly provided at the mount port, and the end cover is rotatably connected to the filter cartridge body through the rotatable connector. The outer peripheral wall of the end cover is provided with a second snap member corresponding to the first snap member, and the first snap member and the second snap member engage with each other in a threaded fit, to lock the filter cartridge body inside the mount cavity, where a ratio of a sum of abutment area between the first snap member and the second snap member to a sum of water passage area of the first interface is greater than or equal to 1.3 and less than or equal to 3.

The above one or more solutions in the embodiments of the present application have at least one of the following technical effects.

By using a matching design in a manner of rotating and snapping between the first snap member and second snap member in the present application, the filter cartridge body may be tightly fixed inside the mount cavity, and by reasonably setting the ratio of the sum of abutment area between the first snap member and the second snap member to the sum of water passage area of the first interface, a suitable strength of a fixed structure of the filter cartridge assembly may be set based on specific water flow rate of the filter cartridge assembly, which effectively ensures the strength of the fixed structure while reducing the design margin, thereby enabling a miniaturization design of the filter cartridge assembly. In an embodiment, in case that the ratio is less than or equal to 3, the sum of the abutment area is relatively large, which provides better structural stability and improves the structural performance of the filter cartridge assembly. At the same time, the sum of water passage area is also relatively large, which ensures a suitable water flow rate and meets filtration requirements. In case that the ratio is less than 1.3, a difference between the sum of the abutment area and the sum of water passage area decreases, which means that a force required to fix the filter cartridge provided by the fixed structure may be less than an axial pressure of the inlet and outlet water, affecting the mount stability of the filter cartridge assembly. In case that the ratio is greater than or equal to 3, the strength of the fixed structure is much greater than the axial pressure of the inlet and outlet water, which means that the strength of the fixed structure is excessive, resulting in an excessively large volume of the filter cartridge assembly and an increase in production costs. By setting the ratio of the sum of abutment area between the first snap member and the second snap member to the sum of water passage area of the first interface to be greater than or equal to 1.3 and less than or equal to 3 in the present application, the water flow rate and the structural strength of the filter cartridge assembly may be well engaged, which further improves the structural performance and filtration efficiency of the filter cartridge assembly.

The additional aspects and advantages of the present application are partially presented in the following description, some of which becomes apparent from the following description, or learned through practice of the present application.

### BRIEF DESCRIPTION OF THE DRAWINGS

To clearly illustrate the solutions in the embodiments of the present application, the drawings used in the description of the embodiments are briefly described below. The drawings in the following description are only some embodiments of the present application, and other drawings may be obtained according to these drawings without any creative work for those skilled in the art.

FIG. 1 is a schematic structural diagram of a water purification device according to an embodiment of the present application;

FIG. 2 is a sectional view of a water purification device according to an embodiment of the present application;

FIG. 3 is an enlarged view of position A in FIG. 2;

FIG. 4 is a schematic assembly diagram of a filter cartridge body and an end cover in FIG. 2;

FIG. 5 is a bottom view of a filter cartridge body and an end cover in FIG. 4;

FIG. 6 is a front view of a filter cartridge body and an end cover in FIG. 3; and

FIG. 7 is a schematic assembly diagram of a filter cartridge body and an end cover from another perspective in FIG. 6.

### REFERENCE NUMERALS

10: water purification device;
100: filter cartridge assembly;
110: filter cartridge base body; 111: mount cavity; 112: mount port; 112a: guide slot;
120: filter cartridge body; 121: first interface;
130: end cover; 131: snap protrusion; 131a: abutment surface; 132: flange; 133: grip member; 133a: undercut;
140: water path plate;
200: outer housing.

### DETAILED DESCRIPTION

Implementations of the present application are further described in detail below with reference to the drawings and embodiments. The following embodiments are intended to illustrate the present application, but are not intended to limit the scope of the present application.

In the description of the embodiments of the present application, it should be noted that the orientation or positional relationship indicated by terms such as “center,” “longitudinal,” “lateral,” “upper,” “lower,” “front,” “rear,”“left,” “right,” “vertical,” “horizontal,” “top,” “bottom,” “inside,” “outside,” etc. are based on the orientation or positional relationship shown in the drawings, and are merely for the convenience of describing the embodiments of the present application and simplifying the description, rather than indicating or implying that the device or component stated must have a particular orientation or the device or component stated is constructed and operated in a particular orientation, and thus is not to be construed as limiting the embodiments of the present application. Moreover, the terms “first,” “second,” “third,” and the like are used for descriptive purposes only and are not to be construed as indicating or implying relative importance.

In the description of the present application, it should be noted that, unless explicitly specified and defined otherwise, the terms “connected to” and “connected” shall be understood broadly, for example, it may be either fixedly connected or detachably connected, or may be integrated; it may be either mechanically connected, or electrically connected; it may be either directly connected, or indirectly connected through an intermediate medium. The specific meanings of the terms above in embodiments of the present application may be understood by a person skilled in the art in accordance with specific conditions.

In the embodiments of the present application, unless otherwise clearly stated and defined, a first feature being located “on” or “under” a second feature means that the first feature is in direct contact with the second feature or the first feature is in contact with the second feature by an intervening media. In addition, the first feature is “on,” “above” and “over” the second feature may refer to that the first feature is directly above or obliquely above the second feature, or simply refer to that the level height of the first feature is higher than that of the second feature. The first feature is “under,” “below” and “beneath” the second feature may refer to that the first feature is directly below or obliquely below the second feature, or simply refer to that the level height of the first feature is lower than that of the second feature.

In the description of this specification, the description with reference to the terms “an embodiment,” “some embodiments,” “example,” “specific example,” or “some examples” etc. means that the specific features, structures, materials or characteristics described in conjunction with the embodiment or example are included in at least one embodiment or example of the embodiments of the present application. In this specification, the schematic representations of the above terms do not necessarily refer to the same embodiment or example. Moreover, the specific features, structures, materials or characteristics described may be combined in any one or more embodiments or examples in a suitable manner. In addition, those skilled in the art may integrate and combine the different embodiments or examples described in this specification and the features of the different embodiments or examples, without contradiction.

Water purification product is a type of water purifier, which is a water treatment device that deeply filters and purifies water based on water usage requirements. The water purifier may effectively filter out rust, sand, colloid in the water, absorb residual chlorine, odor, strange color, pesticide and other chemical agents in the water, as well as remove impurities such as bacteria, pathogen, toxin, heavy metal, etc. from the water. It is widely used in both civilian and commercial applications.

In related fields, a connection manner between an end cover and a housing or support base in a filter cartridge assembly is generally rotational mounting by rotating and snapping to replace a filter cartridge. Since an end of a filter cartridge provided with a water inlet port and a water outlet port and an end connected to the end cover are axially opposite ends, in case that a water port of the filter cartridge is along an axial direction, a force required for fixing the filter cartridge is a product of a difference in axial force areas and a water pressure. The difference in force areas are areas of the water inlet port and the water outlet port. However, to ensure structural strength, the traditional filter cartridge assembly has been set to have excessive strength of a fixed structure, resulting in a large volume of the filter cartridge assembly, increased production costs, and an overall increase in a volume of the water purification device, which affects user experiences.

The present application provides a filter cartridge assembly and a water purification device.

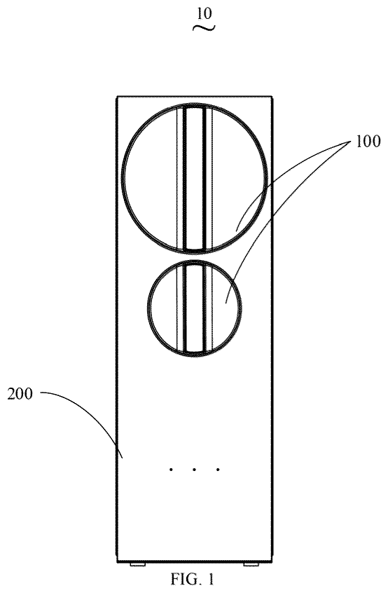

In the embodiments of the present application, as shown in FIG. 1 to FIG. 3, the filter cartridge assembly 100 includes a filter cartridge base body 110, a filter cartridge body 120, and an end cover 130. The filter cartridge base body 110 is provided with a mount cavity 111 and a mount port 112 communicating with the mount cavity 111. An inner wall of the mount port 112 is provided with a first snap member, where the first snap member is provided to extend obliquely along a circumference direction of the mount port 112. The filter cartridge body 120 is provided inside the mount cavity 111, an end of the filter cartridge body 120 is provided with a first interface 121 communicating with a water path plate 140, and another end of the filter cartridge body 120 is provided with a rotatable connector. The end cover 130 is correspondingly provided at the mount port 112, and the end cover 130 is rotatably connected to the filter cartridge body 120 through a rotatable connector. The outer peripheral wall of the end cover 130 is provided with a second snap member corresponding to the first snap member, and the first snap member and the second snap member engage with each other in a threaded fit, to lock the filter cartridge body 120 inside the mount cavity 111, where a ratio of a sum of abutment area between the first snap member and the second snap member to a sum of water passage area of the first interface 121 is greater than or equal to 1.3 and less than or equal to 3.

The filter cartridge base body 110 may be a separate mount support base from an outer housing 200, or the filter cartridge base body 110 and the outer housing 200 may be integrally formed. The filter cartridge base body 110 is provided with the mount cavity 111 and the mount port 112 communicating with the mount cavity 111. The mount cavity 111 provides a stable mount space for the filter cartridge body 120, and the mount port 112 allows easy insertion and removal of the filter cartridge body 120, which also ensures that water or other fluids may flow into and pass through the filter cartridge body 120. At the inner wall of the mount port 112, there may be provided with a plurality of first snap members arranged in axial symmetry. The first snap members provide mount fixation positions. As such, the second snap members at the end cover 130 may match with the first snap members in a manner of rotating and snapping, to fix the filter cartridge body 120 inside the mount cavity 111 in an axial direction.

The filter cartridge body 120 is provided inside the mount cavity 111, and an end of the filter cartridge body 120 is provided with the first interface 121 communicating with the water path plate 140. A second connection port may be provided at the water path, and the first interface 121 may be connected and engaged with the second connection port through plugging, to communicate the filter cartridge body 120 with the water path plate 140. Another end of the filter cartridge body 120 is provided with a rotatable connector, to allow a rotational connection between the end cover 130 and the filter cartridge body 120. In this way, a limitation in an axial direction between the filter cartridge body 120 and the water path plate 140 may be provided through the end cover 130, and then the filter cartridge body 120 does not need to rotate during a procedure for fixing, which eliminates a rotatable structure correspondingly provided at the water path plate 140, further simplifies the structure of the water path plate 140, and is convenient for users to operate.

It should be noted that the first interface 121 may include a first water inlet port, a first water outlet port, and a first waste water port, and the second connection port may include a second water inlet port, a second water outlet port, and a second waste water port. The first water inlet port and the second water inlet port are engaged with and connected to each other through plugging, the first water outlet port and the second water outlet port are engaged with and connected to each other through plugging, and the first waste water port and the second waste water port are engaged with and connected to each other through plugging, thereby communicating the filter cartridge body 120 with the water path plate 140.

The end cover 130 is correspondingly provided at the mount port 112, and the end cover 130 is rotatably connected to the filter cartridge body 120 through the rotatable connector, to ensure that the end cover 130 may tightly cover the mount port 112. In case that the filter cartridge assembly 100 is mounted at a water path system, the end cover 130 may tightly fix the filter cartridge body 120 inside the mount cavity 111 of the filter cartridge base body 110 through matching of the second snap member and the first snap member in a manner of rotating and snapping. As such, the filter cartridge body 120 may be prevented from rotating or moving during operation, thereby ensuring the normal operation of the filter cartridge assembly 100. It should be noted that the inner wall of the mount port 112 may be provided with a plurality of first snap members arranged in axial symmetry, and the corresponding outer peripheral wall of the end cover 130 may also be provided with a plurality of second snap members.

By using a matching design in a manner of rotating and snapping between the first snap member and second snap member in the present application, the filter cartridge body 120 may be tightly fixed inside the mount cavity 111, and by reasonably setting the ratio of the sum of abutment area between the first snap member and the second snap member to the sum of water passage area of the first interface 121, a suitable strength of a fixed structure of the filter cartridge assembly 100 may be set based on specific water flow rate of the filter cartridge assembly 100, which effectively ensures the strength of the fixed structure while reducing the design margin, thereby enabling a miniaturization design of the filter cartridge assembly 100. In an embodiment, in case that the ratio is less than or equal to 3, the sum of the abutment area is relatively large, which provides better structural stability and improves a structural performance of the filter cartridge assembly 100. At the same time, the sum of water passage area is also relatively large, which ensures a suitable water flow rate and meets filtration requirements. In case that the ratio is less than 1.3, a difference between the sum of the abutment area and the sum of water passage area decreases, which means that a force required to fix the filter cartridge provided by the fixed structure may be less than an axial pressure of the inlet and outlet water, affecting the mount stability of the filter cartridge assembly 100. In case that the ratio is greater than or equal to 3, the strength of the fixed structure is much greater than the axial pressure of the inlet and outlet water, which means that the strength of the fixed structure is excessive, resulting in an excessively large volume of the filter cartridge assembly 100 and an increase in production costs. By setting the ratio of the sum of abutment area between the first snap member and the second snap member to the sum of water passage area of the first interface 121 to be greater than or equal to 1.3 and less than or equal to 3 in the present application, the water flow rate may well match the structural strength of the filter cartridge assembly 100, which further improves the structural performance and filtration efficiency of the filter cartridge assembly 100.

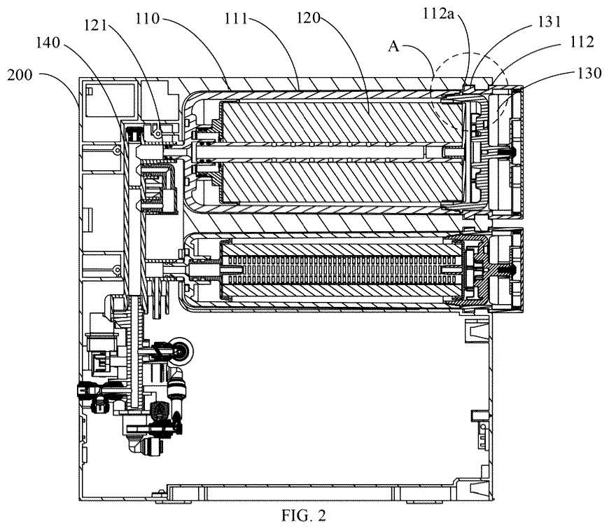

Referring to FIG. 2 to FIG. 4, in some embodiments, one of the first snap member and the second snap member is a snap protrusion 131, and another is a guide slot 112a. In some embodiments, according to actual needs, the inner wall of the mount port 112 may be provided with the guide slot 112a, and the outer peripheral wall of the end cover 130 may be provided with the snap protrusion 131; or the outer peripheral wall of the end cover 130 may be provided with the guide slot 112a, and the inner wall of the mount port 112 may be provided with the snap protrusion 131. The embodiment is illustrated by taking an example of providing the guide slot 112a at the inner wall of the mount port 112 and providing the snap protrusion 131 at the outer peripheral wall of the end cover 130. Other embodiments may refer to this embodiment for implementation, and are not specifically limited here. The snap protrusion 131 is provided to protrude along a radial direction of the end cover 130 and extends along the circumference direction of the end cover 130. The guide slot 112a extends along the circumferential direction of the inner wall of the mount port 112 and communicates with the mount port 112. As such, the snap protrusion 131 enters and exits the guide slot 112a through the mount port 112, and slides in a direction of the extension of the guide slot 112a to abut and match, to fix the end cover 130 at the mount port 112 or unlock the end cover 130 from the mount port 112. Through the combination of the snap protrusion 131 and the guide slot 112a, a simple and reliable connection for the filter cartridge assembly 100 may be provided.

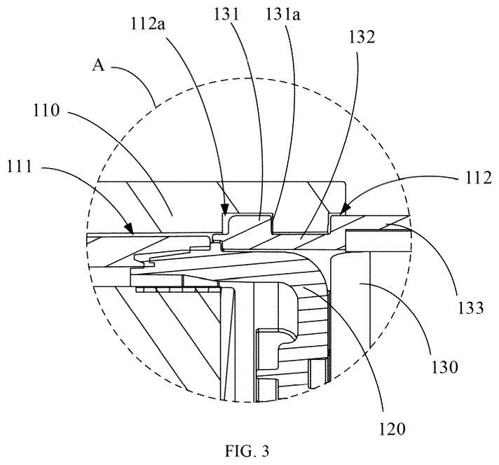

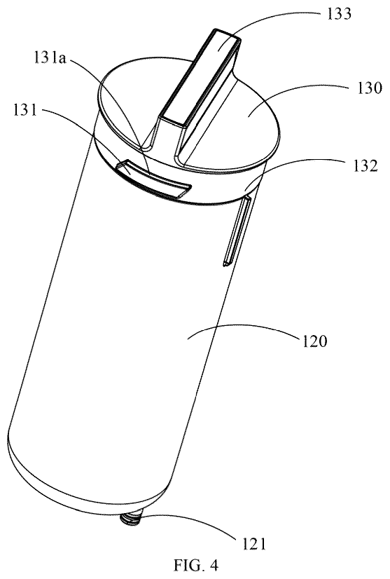

Referring to FIG. 3 and FIG. 4, in some embodiments, the snap protrusion 131 is provided with an abutment surface 131a facing away from a side of the filter cartridge body 120, where the abutment surface 131a is provided to abut against a side wall of the guide slot 112a facing the filter cartridge body 120 in an axial direction. In some embodiments, since the first interface 121 is provided at another end of the filter cartridge body 120 opposite to the end cover 130 along an axis direction, to overcome a pressure on the filter cartridge body 120 in a direction of facing the end cover 130 exerted by a water pressure at the first interface 121, where the filter cartridge body 120 is located inside the mount cavity 111 through an axial limitation of the end cover 130, the pressure in the axial direction is counteracted by abutting matching of the snap protrusion 131 and the guide slot 112a. In case that the filter cartridge body 120 is subjected to a pressure facing the direction of the end cover 130, the abut of the snap protrusion 131 and the guide slot 112a is achieved through that the abutment surface 131a abuts against the side wall of the guide slot 112a facing the filter cartridge body 120 in an axial direction, to provide a reaction force in the axial direction. Therefore, the size of the abutment surface 131a is related to a size of the abutment area between the snap protrusion 131 and the guide slot 112a, thus affecting the ratio of the sum of abutment area between the first snap member and the second snap member to the sum of water passage area of the first interface 121. Therefore, it is possible to set different sizes of the abutment surface 131a based on the required structural strength to meet the requirements of different flow rates of the filter cartridge assembly 100, to improve the rationality of the setting of the filter cartridge assembly 100.

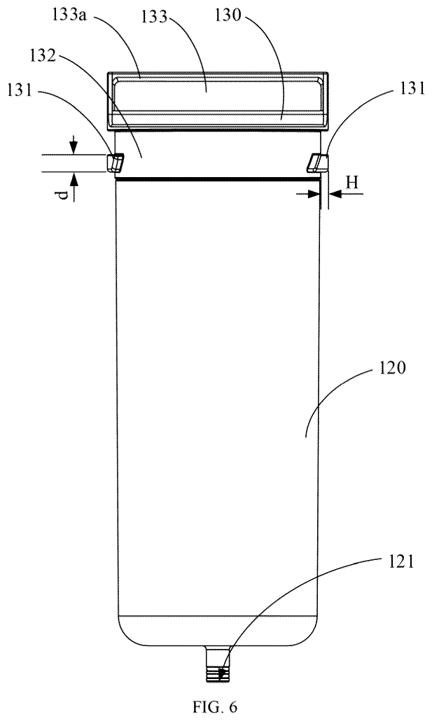

Referring to FIG. 6, in some embodiments, a height H of the snap protrusion 131 protruding in a radial direction is greater than or equal to 2.5 mm and less than or equal to 6.5 mm. In some embodiments, while keeping other parameters constant, the higher the height of the snap protrusion 131 protruding in the radial direction is, the larger the area of the abutment surface 131a of the snap protrusion 131 abutting against the guide slot 112a is, to ensure the abut strength between the snap protrusion 131 and the guide slot 112a. However, if the height of the snap protrusion 131 protruding in the radial direction is too high, it increases a radius of the filter cartridge assembly 100 in the axial direction, resulting in an increase in the volume of the filter cartridge assembly 100; but if the height of the snap protrusion 131 protruding in the radial direction is too small, due to assembly and process errors, the abutment area between the snap protrusion 131 and the guide slot 112a cannot be ensured, which cannot ensure the reliability of the filter cartridge assembly 100. Therefore, in some embodiments, the height H of the snap protrusion 131 protruding in the radial direction is set in a range of 2.5 mm to 6.5 mm, to ensure the abut strength between the snap protrusion 131 and the guide slot 112a.

In an embodiment, the height H of the snap protrusion 131 protruding in the radial direction may be 2.5 mm, 3 mm, 3.5 mm, 4 mm, 4.5 mm, 5 mm, 5.5 mm, 6 mm, or 6.5 mm, etc., and may be selected based on specific design requirements. No special restrictions are made here.

Referring to FIG. 6, in some embodiments, a thickness d of the snap protrusion 131 along the axis direction is greater than or equal to 5 mm and less than or equal to 12 mm. In some embodiments, the thicker the thickness of the snap protrusion 131 along the axis direction is, the stronger the connection strength between the snap protrusion 131 and the end cover 130 is. In a case where the height of the snap protrusion 131 protruding in the radial direction is larger, to prevent structural fracture between the snap protrusion 131 and the end cover 130, it is also necessary to increase the thickness of the snap protrusion 131 along the axis direction, to improve the stability of the structure between the snap protrusion 131 and the end cover 130.

In an embodiment, the thickness d of the snap protrusion 131 along the axis direction may be 5 mm, 6 mm, 7 mm, 8 mm, 9 mm, 10 mm, 11 mm, or 12 mm, etc., which may be selected based on specific design requirements. No special restrictions are made here.

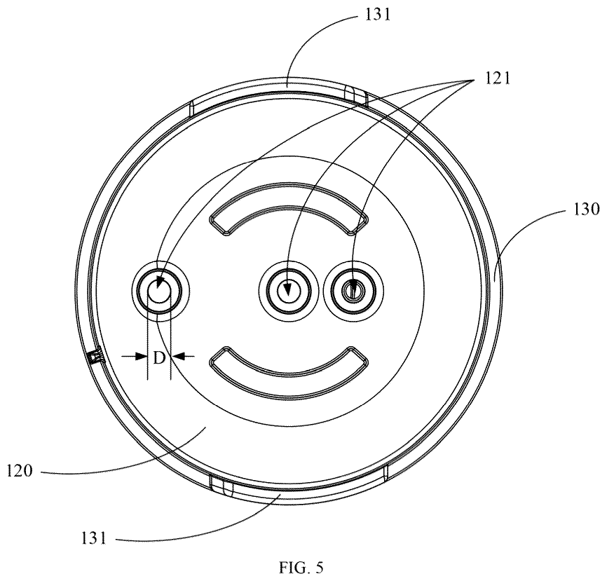

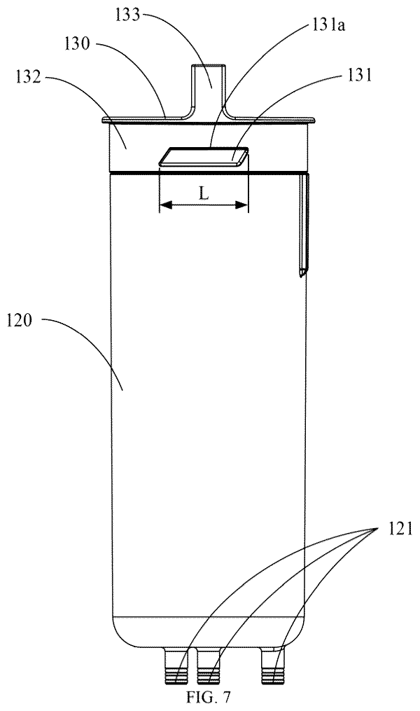

Referring to FIGS. 5 and 7, in some embodiments, a length of the snap protrusion 131 extending in the circumferential direction is L, and a diameter of the first interface 121 is D. A ratio of a sum of lengths of all snap protrusions 131 extending in the circumferential direction to a sum of diameters of all first interfaces 121 is greater than or equal to 3 and less than or equal to 7. In some embodiments, while keeping other parameters constant, the longer the length of the snap protrusion 131 extending in the circumferential direction is, the larger the abutment area between the snap protrusion 131 and the guide slot is; and the larger the diameter of the first interface 121 is, the larger the water passage area of the first interface 121 is. Therefore, the larger the ratio of the sum of the lengths of all snap protrusions 131 extending in the circumferential direction to the sum of the diameters of all first interfaces 121 is, the stronger the abut strength between the snap protrusion 131 and the guide slot 112a is. However, the longer the length of the snap protrusion 131 extending in the circumferential direction, the more it affects the matching between the snap protrusion 131 and the guide slot 112a in a manner of rotating and snapping. On the contrary, the smaller the ratio of the sum of the lengths of all snap protrusions 131 extending in the circumferential direction to the sum of the diameters of all first interfaces 121 is, the weaker the abut strength between the snap protrusion 131 and the guide slot 112a is.

In an embodiment, the ratio of the sum of the lengths of all snap protrusions 131 extending in the circumferential direction to the sum of the diameters of all first interfaces 121 may be 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, or 7.0, etc., which may be selected based on specific design requirements. No special restrictions are made here.

Referring to FIG. 3, FIG. 6 and FIG. 7, in some embodiments, a side of the end cover 130 away from the filter cartridge body 120 is raised to form a grip member 133. In some embodiments, a part of the end cover 130 protrudes in a direction away from the filter cartridge body 120 to form a gripable shape, and an operator may easily hold the end cover 130 and operate the end cover 130. The side of the end cover 130 away from the filter cartridge body 120 is raised to form the grip member 133, and a handle may be provided for the operator for handing in a case of replacement or assembly. The shape of the grip member 133 may be a shape suitable for sizes of human hands, such as a circle, a rectangle or a semicircle, and the operator may easily hold and operate it.

In some embodiments, an outer peripheral edge of an end of the grip member 133 away from the filter cartridge body 120 protrudes to form an undercut 133a. In some embodiments, a structure of the undercut 133a may make it easier for the user to grip the filter cartridge, especially when the grip member 133 is protruding, the user may more conveniently grasp the filter cartridge. It is easier to mount, replace or handle the filter cartridge. In addition, by designing the undercut 133a structure at the grip member 133, the convenience of the user in operating the filter cartridge may be improved. No matter of mounting the filter cartridge into a device or replacing the filter cartridge, the structure of the undercut 133a allows the user to grip the filter cartridge more easily and firmly, thereby improving user-friendliness of a product. The user may feel more comfortable and convenient when using the filter cartridge, thereby improving the overall user experience.

In an embodiment, a raise distance of the grip member 133 along an axial direction of the end cover 130 is h, where h is greater than or equal to 12 mm. In some embodiments, a larger raise distance of the grip member 133 may provide a better handle lever, allowing the user to better control and operate the filter cartridge. The larger raise distance may provide a better grip force and comfort experience. The raise distance may be selected based on the size of the filter cartridge or arrangement requirements, which is not specifically limited here.

Referring to FIG. 3, FIG. 4, FIG. 6, and FIG. 7, in some embodiments, an outer periphery edge of the end cover 130 toward the filter cartridge body 120 is provided with a flange 132, the flange 132 is provided to cover the end of the filter cartridge body 120 provided with the rotatable connector, and the snap protrusion 131 is provided at an outer wall surface of the flange 132. In some embodiments, by providing the flange 132, the end cover 130 may cover an end of the filter cartridge body 120 and provide an embedded space to accommodate the rotatable connector of the filter cartridge body 120. Through the combination of the rotatable connector and the end cover 130, the end cover 130 may be firmly fixed at the filter cartridge body 120. Meanwhile, the flange 132 may further provide a position for providing the snap protrusion 131.

The present application further provides a water purification device 10, and the water purification device 10 includes an outer housing 200 and a filter cartridge assembly 100. A specific structure of the filter cartridge assembly 100 refers to the above embodiments. Since the present water purification device 10 adopts all the solutions of all the above embodiments, it at least has all the beneficial effects brought by the solutions of the above embodiments, which are note described one by one here.

It should be noted that, the above embodiments are only used to illustrate the present application, but not to limit the present application. Although the present application has been described in detail with reference to the embodiments, those skilled in the art should understand that various combinations, modifications, or equivalent replacements of the solutions of the present application do not depart from the scope of the solutions of the present application, and should be all covered by the scope of the claims of the present application.

1.-10. (canceled)

11. A filter cartridge assembly comprising:
a filter cartridge base body provided with a mount cavity and a mount port communicating with the mount cavity, an inner wall of the mount port being provided with one or more first snap members extending obliquely along a circumference direction of the mount port;
a filter cartridge body inside the mount cavity, a first end of the filter cartridge body being provided with one or more interfaces communicating with a water path plate, and a second end of the filter cartridge body being provided with a rotatable connector; and
an end cover provided at the mount port and connected to the filter cartridge body through the rotatable connector, an outer peripheral wall of the end cover being provided with one or more second snap members corresponding to the one or more first snap members, respectively, and each engaging with a corresponding one of the one or more first snap members in a threaded fit, to lock the filter cartridge body inside the mount cavity;
wherein a ratio of a sum of abutment areas between the one or more first snap members and the one or more second snap members to a sum of water passage areas of the one or more interfaces is greater than or equal to 1.3 and less than or equal to 3.

12. The filter cartridge assembly of claim 11, wherein in each pair of first snap member and second snap member, one of the first snap member and the second snap member is a snap protrusion, and another one of the first snap member and the second snap member is a guide slot.

13. The filter cartridge assembly of claim 12, wherein the snap protrusion is provided with an abutment surface away from a side of the filter cartridge body and abutting against a side wall of the guide slot facing the filter cartridge body in an axial direction.

14. The filter cartridge assembly of claim 12, wherein a height of the snap protrusion protruding in a radial direction is greater than or equal to 2.5 mm and less than or equal to 6.5 mm.

15. The filter cartridge assembly of claim 12, wherein a thickness of the snap protrusion along an axis direction is greater than or equal to 5 mm and less than or equal to 12 mm.

16. The filter cartridge assembly of claim 12, wherein a ratio of a sum of lengths of the one or more snap protrusions extending in a circumferential direction to a sum of diameters of the one or more interfaces is greater than or equal to 3 and less than or equal to 7.

17. The filter cartridge assembly of claim 12, wherein an outer periphery edge of the end cover toward the filter cartridge body is provided with a flange covering the second end of the filter cartridge body, and the snap protrusion is provided at an outer wall surface of the flange.

18. The filter cartridge assembly of claim 11, wherein a side of the end cover away from the filter cartridge body is raised to form a grip member, and an outer peripheral edge of an end of the grip member away from the filter cartridge body protrudes to form an undercut.

19. The filter cartridge assembly of claim 18, wherein a raise distance of the grip member along an axial direction of the end cover is greater than or equal to 12 mm.

20. A water purification device comprising:
an outer housing; and
a filter cartridge assembly arranged in the outer housing and including:
a filter cartridge base body provided with a mount cavity and a mount port communicating with the mount cavity, an inner wall of the mount port being provided with one or more first snap members extending obliquely along a circumference direction of the mount port;
a filter cartridge body inside the mount cavity, a first end of the filter cartridge body being provided with one or more interfaces communicating with a water path plate, and a second end of the filter cartridge body being provided with a rotatable connector; and
an end cover provided at the mount port and connected to the filter cartridge body through the rotatable connector, an outer peripheral wall of the end cover being provided with one or more second snap members corresponding to the one or more first snap members, respectively, and each engaging with a corresponding one of the one or more first snap members in a threaded fit, to lock the filter cartridge body inside the mount cavity;
wherein a ratio of a sum of abutment areas between the one or more first snap members and the one or more second snap members to a sum of water passage areas of the one or more interfaces is greater than or equal to 1.3 and less than or equal to 3.

21. The water purification device of claim 20, wherein in each pair of first snap member and second snap member, one of the first snap member and the second snap member is a snap protrusion, and another one of the first snap member and the second snap member is a guide slot.

22. The water purification device of claim 21, wherein the snap protrusion is provided with an abutment surface away from a side of the filter cartridge body and abutting against a side wall of the guide slot facing the filter cartridge body in an axial direction.

23. The water purification device of claim 21, wherein a height of the snap protrusion protruding in a radial direction is greater than or equal to 2.5 mm and less than or equal to 6.5 mm.

24. The water purification device of claim 21, wherein a thickness of the snap protrusion along an axis direction is greater than or equal to 5 mm and less than or equal to 12 mm.

25. The water purification device of claim 21, wherein a ratio of a sum of lengths of the one or more snap protrusions extending in a circumferential direction to a sum of diameters of the one or more interfaces is greater than or equal to 3 and less than or equal to 7.

26. The water purification device of claim 21, wherein an outer periphery edge of the end cover toward the filter cartridge body is provided with a flange covering the second end of the filter cartridge body, and the snap protrusion is provided at an outer wall surface of the flange.

27. The water purification device of claim 20, wherein a side of the end cover away from the filter cartridge body is raised to form a grip member, and an outer peripheral edge of an end of the grip member away from the filter cartridge body protrudes to form an undercut.

28. The filter cartridge assembly of claim 27, wherein a raise distance of the grip member along an axial direction of the end cover is greater than or equal to 12 mm.
